(19) United States
(12) Patent Application Publication
(10) Pub. No.: US 2005/0214349 A1
(43) Pub. Date: Sep. 29, 2005

(54) Extruded gluten based pet chew bodies

(76) Inventors: Li Nie, Kansas City, MO (US); Sukh D. Bassi, Atchison, KS (US); Clodualdo C. Maningat, Platte City, MO (US)

Correspondence Address: LATHROP & GAGE LC, 4845 PEARL EAST CIRCLE, SUITE 300, BOULDER, CO, 80301, US

(21) Appl. No.: 11/050,205

(22) Filed: Feb. 3, 2005

Related U.S. Application Data
(63) Continuation-in-part of application No. 10/755,597, filed on Jan. 12, 2004.
Application No. 10/755,597 is a continuation-in-part of application No. 10/284,553, filed on Oct. 30, 2002.

(51) Int. Cl. A23K 1/165

(52) U.S. Cl. 424/442; 426/635

(57) ABSTRACT

A method of forming solid gluten-based pet chew is provided wherein a gluten mixture is heated to a maximum temperature of up to about 80° C. to create a substantially homogeneous and flowable mixture under extrusion processing conditions. The formulation includes from about 40-90% by weight of grain protein, from about 10-40% by weight plasticizer, and at least about 0.01 by weight of a reducing agent such as sodium bisulfite for cleaving disulfide bonds present in the grain protein. Dental health agents including an acidulent and a chelator are added to promote good dental health. Optional ingredients such as fillers, fiber, lubricant/mold release agents and colorants can also be used. The formulations can be processed in extrusion or injection molding equipment.

### RELATED APPLICATIONS

This application is a continuation-in-part of U.S. patent application Ser. No. 10/755,597, filed Jan. 12, 2004, which is a continuation-in-part of U.S. patent application Ser. No. 10/284,553, filed Oct. 30, 2002. All of the above applications are incorporated herein by reference.

### BACKGROUND

1. Field of the Invention

The present invention relates to extruded gluten-based food products. More particularly, extruded products and methods may provide, for example, long-lasting pet chews that promote good dental health.

2. Description of the Related Art

It is problematic that many animal owners, such as dog owners, periodically need professional help to clean the teeth of their animals. For example, it is common for the owner of a show champion or field trial champion dog to have the teeth cleaned at lest once per year. This type of veterinary attention may require anesthetization of the animal. Without such care, many animals suffer poor dental health due to long term neglect of their teeth.

Current pet chew or pet food product formulations may promote good dental health to the extent that calculus or plaque is removed by scraping as the food product is consumed. By way of example, U.S. Pat. No. 6,672,252 issued to Levin et al. describes a pet chew that is made of a ductile polymer, such as gluten, which contains fibers or hard materials for scraping of the teeth. Animal teeth sink into the pet chew, which physically cleans the teeth by virtue of this contact.

Chemical additives to edible pet products may be associated with palatability issues. U.S. Pat. No. 6,610,276 issued to Melman describes a combination of acetic acid and sodium hexametaphosphate that is effective against microorganisms and works to prevent or inhibit calculus or plaque formation. The formulations include mouthwashes, handwashes, hand sanitizers, surgical scrubs, and veterinary medicines. Although the mouthwashes may be of the ‘swish and swallow’ variety, no formulation is reported that may be consumed as an edible, long lasting pet chew.

U.S. Pat. No. 6,080,419 issued to Stookey describes a pet food that contains phosphoric acid, which is used as an acidulent in combination with maleic acid as a sequestering agent to prevent calculus buildup on animal teeth. The food product cannot contain sodium hexametaphosphate because this is chemically incompatible with phosphoric acid. This is because sodium hexametaphosphate may be used as a sequestering agent, but is inactivated for this use by contact with of phosphoric acid.

Gluten has been used in various polymer compositions, and may even be used to make inedible compositions, as described in U.S. Pat. No. 5,665,152 issued to Bassi et al. The '152 patent describes a method of producing biodegradable non-edible grain protein-based articles. The formulation includes from about 20-85% by weight of grain protein, from about 5-75% by weight starch, up to about 14% by weight water, from about 10-40% by weight plasticizer, and at least about 0.01 by weight of a reducing agent such as sodium bisulfite for cleaving disulfide bonds present in the grain protein.

There remains a need for edible pet chews that contain chemical additives which promote good dental health.

### SUMMARY

The materials and processing described below address the problems outlined above and advance the art by providing a gluten-based extrudate that can be formed into a pet chew or treat having any desired shape. Consumption of the pet chew as an animal treat promotes good dental health by the action of chemical additives that are generally regarded as safe for consumption. Palatability is not an issue, for example, where dogs readily consume these pet chews.

In one embodiment, a pet chew contains a gluten-based matrix. Materials that are mixed and extruded to form the pet chew may contain between about 40-90% gluten by weight, preferably between about 45-80% by weight and more preferably between about 60% to 75% by total weight of the pet chew. An acidulent, such as acetic acid, is present in an effective amount for reducing undesirable flora in the mouth of an animal. More generally, the acidulent is preferably a nontoxic or low toxicity organic acid, such as acetic acid, in an amount ranging from 0.001% to 5% by total weight of the pet chew, more preferably from 0.01% to 3%, and most preferably from 0.1% to 1% by total weight. A chelator is present in an effective amount for reducing calculus buildup. The chelator is preferably sodium hexametaphosphate, which in the form of solid particles having an average diameter up to about 20 microns forms a mild abrasive that facilitates plaque or calculus removal. The chelator may be added in an effective amount to work against plaque or calculus, such as 0.5% or 1% by total weight of the pet chew. The chelator is preferably present in an amount ranging from 0.2% to 0.6% by total weight.

A reducing agent is preferably mixed with the gluten. This ingredient significantly improves the flow and mixing qualities of the mixture in the in the extrusion apparatus by cleaving disulfide bonds in gluten. The reducing agent is normally added to the other mixture components prior to or as a part of the extrusion process. Alternately, the reducing agent can be used to preliminarily treat the gluten prior to preparation of the starting formulation. By way of example, the reducing agent may be added to gluten to obtain a modified gluten product. The modified gluten product may be used as a part of the extrusion formulation. The reducing agent should be used in an effective amount to cleave from about 10% to 100% of the disulfide bonds in the gluten. The reducing agent activity also enhances the final products in terms of appearance, mechanical properties and moisture resistance. The reducing agent should be present in a minor amount of at least about 0.01% by weight of gluten, and more preferably from about 0.05-3% by weight of gluten. The reducing agents are advantageously selected from the group consisting of the alkali metal and ammonium sulfites, bisulfites, metabisulfites and nitrites, and mercaptoethanol, cysteine, cysteamine, ascorbic acid and mixtures thereof. Sodium metabisulfite is particularly preferred.

If corn gluten is used as the primary grain protein starting material, it may be pretreated with a selected reducing agent and a fatty acid or fatty acid salt in an aqueous ammonia solution to form a dispersion at a temperature below about 80° C. This dispersion can then be spray dried to give a modified corn gluten.

A plasticizer may be added in an amount ranging from 10% to 40% by weight of the product and, more preferably, from 10% to 25% by weight of the product. Preferred plasticizers include those selected from the group consisting of glycerol diglycerol, propylene glycol, triethylene glycol, urea, sorbitol, mannitol, maltitol, hydrogenated corn syrup, polyvinyl alcohol, polyethylene glycol, C₁₂-C₂₂ fatty acids and metal salts of such fatty acids, and mixtures thereof. The most preferred plasticizer is glycerol

A minor amount of water may be added in an amount ranging from 2% to 14% by weight of the pet chew. The water content is more preferably from about 2-10% by weight. The presence of excess water leads to a sticky, stretchy extrudate that is less suitable for use as a pet chew. Preferably, the pet chew has a water activity of less than 0.7.

A lubricant/mold release agent is preferably added to facilitate extrusion and improve the appearance of the final product. Examples of lubricant/mold release agents include vegetable and animal oils and fats, the alkali metal and alkaline earth stearates and mixtures thereof. The lubricant/mold release agents may include, for example, corn oil, bees wax, glycerol monostearate, sodium stearate, and/or magnesium stearate. Such agents are typically present at a level of about 0.1 to 5% by weight, and more preferably from 0.5% to 3% by weight of the composition.

If desired, minor amounts of colorant can be added to the starting formulations. Suitable coloring agents include, for example, titanium dioxide, azo dyes, chlorophyll, xanthophyll, carotene, indigo, iron and titanium oxides, and carbon black. The colorants may be preferably added in an amount ranging from 0.2% to 2.0% of the food product.

Preferred but optional ingredients may include fibers. By way of example, suitable fibers may include cellulose fiber, wheat bran, innulin, wood fiber, sisal fiber, and mixtures thereof. The fibers may be added in amounts up to 60% by weight of the composition. The fibers are added as filler and to adjust the texture of the pet chew where the ease of chewing the gluten matrix is generally increased by the addition of fiber. The fiber content is preferably from 1% to 20% of the composition by total weight.

Palatability enhancers may be used to attract the animal to the pet chew. The palatability enhancer is preferably selected from the group consisting of meat and poultry broth concentrate or spray-dried powder, liver and liver digest broth concentrate or powder, hydrolyzed proteins, clove, clove oil, yeast extract, garlic flavor, meat flavors, cheese flavors, fruit flavors, distillery dry feed, smoke flavors and combinations thereof. One particularly preferred palatability enhancer is from a liver source. In preferred formulations, the palatability enhancer may be present in an amount from 0.3% to 15% by weight of the food product, with 5% to 12% being more preferred, and an amount of about 10% being most preferred.

Clove materials are a particularly preferred form of palatability enhancer, and are suitably used alone or in combination with other palatability enhancers. A minor amount of clove powder, for example, from 0.3% to 0.7% by weight of the composition, may permit reduced use of protein-based palatability enhancers, such as liver digest. By way of example, when liver digest is used in combination with clove oil or clove powder, the amount of liver digest may be reduced by half while retaining similar palatability effects. The clove material also functions as a breath freshening agent.

Other breath-freshening agents may include chlorophyll, mint, parsley, and/or kelp. Other minor ingredients may include antioxidants, essential minerals including calcium, nutrients, and herbs. These ingredients by category are preferably each kept to less than 1% by weight of the pet chew composition. Antioxidants can be both natural and synthetic. It is preferable that the breath freshening agents, antioxidants, essential minerals, nutrients and herbs in combination comprise less than 6% and more preferably less than 4% by weight of the final pet chew.

Low toxicity antimicrobial agents may optionally be added in amounts that are effective against undesirable mouth flora. By way of example, these amounts are usually from 0.1% to 2% by weight of the pet chew. Citraacidal that has been subjected to evaporation by removal of water to provide a triple strength product is particularly preferred.

Mildly abrasive materials may be included as filler, such as potassium metaphosphate, tricalcium phosphate, dehydrated calcium phosphate, anhydrous dicalcium phosphate, dicalcium phosphate, calcium pyrophosphate, magnesium orthophosphate, trimagnesium phosphate, calcium carbonate, alumina, aluminum silicate, zirconium silicates, silica, bentonite, and mixtures thereof. These materials are preferably added in amounts ranging from 2% to 5% by total weight of the pet chew.

The food product formulation may be provided in a premix, for example, as a powder. A separate premix including the liquid component may also be provided. The premix formulation may be the same as for the pet chew products, as described above, that results from extrusion processing of the product, of the premix formulation may be altered, for example, by omitting one or more of the liquid components such as water. The premixes promote ease of transport and facilitate storage. Powder premix may be mixed with water and/or other liquids, and subjected to extrusion processing to provide the pet chew. The extrusion processing is generally by screw extrusion equipment under temperature conditions that preferably do not denature the protein until the final stages of extrusion. The processed mixture passes through a die to form an extrudate, which may be shaped, formed and dried to form a final pet chew product.

The powder may be formed into pellets, which can later be used in injection molding equipment. For example, such pellets may be formed by extrusion, using either single or twin screw extruders. However, it is desirable during pellet formation to maintain the temperature of the material within the extruder barrel below about 80° C. to avoid heat denaturation of the protein content of the formulation. Extruded pellets of this character are generally be maintained in closed containers and have a total moisture content less than from about 5-14% by weight to avoid deterioration.

The formulations can be used in conventional screw extrusion processing equipment. The melt temperature inside the barrel of the injection molder is preferably maintained to a level of up to about 80° C., and more preferably up to about 65° C. It is preferred that the initial formulation and forming steps are performed so that the formulation experiences a maximum temperature of up to about 65° C. The extrusion die itself is normally be heated to a temperature of from about 120° C. to 180° C., in order to substantially completely denature the grain protein fraction of the formulation that is being extruded. The other parameters of injection molding such as cycle time (ranging from a few seconds to a few minutes) are conventional.

To give but one example, an extruder that is equipped with a slit die may be used for creating a sheet-type extrudate. The extrudate is fed through downstream heated calendering rolls, which are maintained at a temperature of from about 60° C. to 200° C. for final surface polish and thickness control. Normally, the thickness of such sheeting is at least about 0.1 mm. During calendering, the extrudate is partially dried and the heated rolls may at least partially denature the protein content of the extrudate. Depending upon the starting formulation, the extrudates can have variable light transmittance ranging from transparent to opaque. The sheet products after calendering can be rolled and stored for further processing, e.g., pressure/vacuum-assisted thermal forming.

A variety of extrusion equipment may be used, so long as the equipment is designed to maintain the relatively low temperature conditions within the extruder barrel as described above. To this end, single or twin screw extruders can be employed, with screw configurations that generate relatively low temperatures in the grain protein melt of less than about 80° C. and more preferably up to about 65° C.

While any type of extrusion apparatus may be used, it is preferable to use a twin-screw extruder. Preferably, the mixture is then passed through one or more insert dies thereby forming extrudate strands. The die(s) may be configured so as to produce an extrudate strand having a particular cross-sectional profile, with example profiles being rectangular, circular, and club-shaped. The strand thickness is specially chosen depending upon the size of pet that is ultimately intended to consume the chew product. Preferably the extrudate strand will have a thickness of about ¼ to 1½ inches and more preferably from about ⅜″ to 1 inches. The extrudate is placed on a conveying belt for partial cooling. The reshaping unit or embossing device can be place between the die exit and conveying belt to reshape the extrudate to create better-defined shape and for three-dimensional features. The extrudate or reshaped strands are cut at the end of conveying belt or reshaping unit, transferred to a cooler for cooling to room temperature. After exiting the cooler, the products may be packaged in canisters, zip-lock bags or pouches, hot melt sealed bags, etc

### DETAILED DESCRIPTION

A chew treat body produced in accordance with the instrumentalities described below may contain, for example, respective quantities of wheat gluten, plasticizer, acidulent, chelator, water, palatability enhancer and lubricant. Other ingredients that may be incorporated include dental cleaning ingredients, breathe freshening agents, antioxidants, such essential minerals as calcium, nutrients, herbs, and colorants. The acidulent and chelator promote good dental health by working against undesirable or harmful flora in the pet's mouth. a minor amount of clove powder or clove oil is a particularly preferred palatability enhancer and may be used in combination with other palatability enhancers, such as liver digest.

The acidulent may be, for example, acetic acid, boric acid, hydrochloric acid, maleic acid, benzoic acid, citric acid, lactic acid, malic acid, oxalic acid, tartaric acid, succinic acid, glutaric acid, glycolic acid, gentisic acid, valeric acid, gallic acid, beta-resorcylic acid, acetyl salicylic acid, salicylic acid, perchloric acid, barbituric acid, sulfanilic acid, phytic acid, p-nitro benzoic acid, stearic acid, palmitic acid, oleic acid, myristic acid, lauric acid ethylenediaminetetraacetic acid (EDTA), ethylene glycol-bis{beta-aminoethyl ether}-N,N,N′,N′-tetraacetic acid, diethylenetriamine pentaacetic acid and the like. The acidulent is preferably an organic acid in an amount ranging from 0.001% to 5% by weight of the total composition, more preferably from 0.01% to 3%, and most preferably from 0.1% to 1% by weight. Acetic acid is the most preferred organic acid. Inorganic acids may be used to provide an equivalent acidity.

The dental cleaning agent also includes a chelator that works against plaque or calculus buildup. The chelator is chemically compatible with the acidulent. Preferred forms of chelators may also function as a mild abrasive. Suitable chelators include, for example, ethylenediaminetatraacetic acid, edetate sodium, edetate disodium, edetate trisodium, edetate calcium disodium, deferoxamine, ditiocarb sodium, aluminum salts, citric acid-sodium salt, gluconic acid-sodium salt, tartaric acid, sodium hexametaphosphate, anthranilic acid, phosphonate, polyacrylic acid, alkyl-diamine polyacetic acids and salts, penicillamine, pentetic acid, succimer and trientine. A preferred chelator is sodium hexametaphosphate, which when formed of solid particulates having an average diameter up to about 20 microns provides a mild abrasive that facilitates physical removal of plaque or calculus, in addition to its chemical activity as a chelator. The chelator may be added in an effective amount to work against plaque or calculus, such as 0.5% or 1% by weight in the case of sodium hexametaphosphate. The chelator is preferably present in an amount ranging form 0.2% to 0.6% by weight of the pet chew.

The formulation thus described is effective to reduce undesirable flora in the mouth of the animal. These flora include, without limitation, such micro-organisms as Candida albicans, Cryptococcus neoformans, Aspergillus fumigatus, Candida krusei, Candida parapsilosis, Candida tropicalis, Malassezia species, Trichophyton rubrum, Epidermophyton species, Microsporum species, Sporothrix species, Blastomyces dermatitidis, Coccidiodes immiitis, Histoplasma capsulatum, Staphylococcus aureus, Streptococcus faecalis, Escherichia coli, Pseudomonas aeruginosa, Enterobacter aerogenes, Kiebsiella pneumoniae, Staphylococcus epidermis, Zanthomonus maltrophilia, Acinetobacter, Enterobacter cloacae, Serratia marscens, Listeria, Monocytogenes, Enterococcus faecalis, Streptococcus pyogenes, Streptococcus pneumonia, Viridans streptococci, Haemophilus influenzae, Proteus mirabills, Proteus vulgaris and Bacterioides fragilis among many others.

The following examples set forth preferred extruded, self-sustaining bodies hereof and preferred methods of forming the same. It is to be understood, however, that these examples are provided by way of illustration using preferred method s and materials, and as such should not be unduly construed to limit the scope of the invention.

### EXAMPLE 1

### Gluten-based Product Formulation to Promote Dental Health

Wheat gluten protein based treats were produced by an extrusion process. The liquid and premix powder were mixed in a pre-conditioner of a 80-mm Wenger twin screw extruder The product was run at 350 lbs/hr on the powder feed rate at a screw rpm of 130 rpm. The barrel temperature was set at 160° F. from the feed end to 200° F. towards the die end with a gradual transition on the temperature profile. A die insert with a star shape was used to form the shape of the products. The short treats were made with a die face cutter to about ¼″ thickness with a star's tip diameter of ¾″. The treats were pneumatically transferred to a cooler to cool down to room temperature. The products were packed into bags of different sizes that contained different numbers of treats by count.

Table 1 lists one formulation for gluten-based treats. The weights presented in Table 1 are presented in two bases including total powder weight percent and total weight percent of the mixture that is fed into the extruder.

TABLE 1
Gluten Based Dental Health Treat Formulation

| | Parts By Weight | Parts By Weight |
|---|---|---|
| | (% based on total | (% based on weight |
| Ingredients | weight | of total powder) |
| Powder feed | | |
| Gluten | 70.50 | 90.15 |
| Spray dried pork liver | 2.74 | 3.5 |
| digest (ADF 030820) | | |
| Cellulose fiber (solka floc 900) | 1.95 | 2.5 |
| Glycerine monostearate | 1.76 | 2.25 |
| Magnesium stearate | 0.63 | 0.8 |
| Clove | 0.39 | 0.5 |
| Sodium Hexametaphosphate | 0.23 | 0.3 |
| (SHMP) | | |
| Total powder mix | 78.20 | 100 |
| Liquid feed | | |
| Acetic acid | 0.16 | 0.2 |
| Citracidal (Triple strength) | 0.04 | 0.05 |
| Glycerine | 18.37 | 23.5 |
| Sodium metabisulfite | 0.10 | 0.125 |
| Water | 3.13 | 4.0 |
| Total liquid feed | 21.80 | 27.875 |
| Total | 100 | 127.875 |

A more elongate treat may be made with a belt cutter, for example, where the elongated profile travels and cools on the belt. At the end of the belt cutter, the profile may be cut with a knife in to 3″ long pieces. The pieces are transferred with a elevator into a cooler for further cooling to room temperature. After cooling, the treats maintain their profile shape with a sharp star design on the cross-section area.

The resultant pet chews were given to a variety of dogs, which were observed as they consumed the pet chews. Conclusions from the observations were that the treats were sufficiently non-brittle to form long lasting pet chews. Palatability was deemed to be sufficient, since the dogs were attracted to the pet chews as treats and generally stayed with the job of consumption until the treats were gone. This formulation is, accordingly, an effective vehicle for cleaning canine teeth and for the delivery of generally-regarded-as-safe chemical agents that promote good dental health in dogs.

### EXAMPLES 2-4

### Gluten-based Product Formulations to Promote Dental Health

Table 2 below shows additional product formulations as hypothetical examples 2-7. The weights presented in Table 2 are presented in two bases including total powder weight percent and total weight percent of the mixture that is fed into the extruder.

| | Example 2 | Example 3 | Example 4 |
|---|---|---|---|
| | (% by weight) | (% by weight) | (% by weight) |
| | Basis: | Basis: | Basis: |
| | total weight | total weight | total weight |
| | total | total | total |
| Ingredients | powder wt. | powder wt. | powder wt. |
| Powder feed | | | |
| wheat gluten¹ | 64.12 | 40.72 | 63.87 |
| | 80 | 50 | 80 |
| cellulose fiber² | 15.07 | 40.15 | |
| | 18.8 | 49.3 | |
| wood fiber³ | — | — | 15.17 |
| | — | — | 19 |
| clove | 0.56 | 0.33 | 0.48 |
| | 0.7 | 0.4 | 0.6 |
| | 0.40 | 0.24 | 0.32 |
| sodium | 0.40 | 0.24 | 0.32 |
| hexametaphosphate | 0.5 | 0.3 | 0.4 |
| Total solids | 80.15 | 81.45 | 79.83 |
| | 100 | 100 | 100 |
| Liquid Feed | | | |
| glycerol | 16.03 | 13.85 | 15.97 |
| | 20 | 17 | 20 |
| water | 1.60 | 2.44 | 2.40 |
| | 2 | 3 | 3 |
| citracidal (triple | 0.06 | 0.07 | 0.05 |
| strength) | 0.07 | 0.08 | 0.06 |
| sodium bisulfite | 0.16 | 0.16 | 0.16 |
| | 0.2 | 0.2 | 0.2 |
| glycerol monostearate | 0.32 | 0.24 | 0.40 |
| | 0.4 | 0.3 | 0.5 |
| magnesium stearate | 1.28 | 0.98 | 1.20 |
| | 1.6 | 1.2 | 1.5 |
| colorants | 0.40 | 0.81 | — |
| | 0.5 | 1.0 | — |
| | green | pearl | |
| Total Liquids | 19.85 | 18.55 | 20.17 |
| | 24.77 | 22.78 | 25.26 |
| Total | 100 | 100 | 100 |
| | 124.77 | 122.78 | 125.26 |

¹Vital wheat gluten from Midwest Grain Products, Inc.
²Solka Flock from Protein Technologies, Int.
³310 sisal fiber from International Filler corporation.

The foregoing embodiments teach by way of example, and not by limitation. Those skilled in the art understand that insubstantial changes may be made to the disclosed embodiments, and such changes may fall within the scope and spirit of the invention. Accordingly, the inventors hereby state their intention to rely upon the Doctrine of Equivalents in protecting their full rights to what is claimed.

1. A pet chew comprising:
a gluten matrix;
an acidulent in an effective amount for reducing undesirable flora in the mouth of an animal; and
a chelator in an effective amount for reducing calculus buildup in the mouth of an animal.

2. The pet chew of claim 1, wherein the gluten matrix comprises an amount ranging from 40% to 90% by weight of the pet chew.

3. The pet chew of claim 2, wherein the acidulent is present in an amount ranging from 0.001% to 5% by weight of the pet chew.

4. The pet chew of claim 3, where the acidulent includes an organic acid.

5. The pet chew of claim 4, wherein the organic acid comprises acetic acid.

6. The pet chew of claim 3, wherein the chelator is present in an amount ranging from 0.5% or 1% by total weight of the pet chew.

7. The pet chew of claim 6, wherein the chelator comprises sodium hexametaphosphate.

8. The pet chew of claim 1, further comprising a plasticizer in an amount ranging from 10% to 40% by weight of the pet chew.

9. The pet chew of claim 1, further comprising a plasticizer in an amount ranging from 10% to 25% by weight of the pet chew.

10. The pet chew of claim 9, the plasticizer being selected from the group consisting of glycerine, propylene glycol, and mixtures thereof.

11. The pet chew of claim 10, the plasticizer comprising glycerine.

12. The pet chew product of claim 10, further comprising water in an amount ranging from 1% to 14% by weight of the pet chew.

13. The pet chew of claim 1, further comprising a lubricant in an amount ranging from 0.1% to 5.0% of the pet chew.

14. The pet chew of claim 13, the lubricant being selected from the group consisting of glycerol monostearate, glycerol monolaurate, hydrolyzed lecithin and derivatives, hydrolyzed vegetable oils, magnesium stearate, calcium stearate, and mixtures thereof.

15. The pet chew of claim 13, wherein the lubricant comprises glycerol monostearate.

16. The pet chew of claim 1, further comprising a palatability enhancer in an amount ranging from 0.3% to 15% by weight of the pet chew.

17. The pet chew of claim 16, the palatability enhancer being selected from the group consisting of meat and poultry broth concentrate or spray-dried powder, liver and liver digest broth concentrate or powder, hydrolyzed proteins, clove, clove oil, yeast extract, garlic flavor, meat flavors, cheese flavor, fruit flavor, distillery dry feed, smoke flavor and combinations thereof.

18. The pet chew of claim 17, wherein the palatability enhancer comprises clove powder mixed with another member of the group.

19. The pet chew of claim 16, wherein the palatability enhancer comprises clove powder.

20. The pet chew of claim 1 further comprising one or more additional ingredients selected from the group consisting of coloring agents, antioxidants, essential minerals including calcium, nutrients, herbs, flavoring agents, dental cleaning agents, and breath fresheners.

21. The pet chew of claim 20, wherein the additional ingredient comprises the breath freshening agent selected from the group consisting of chlorophyll mint, parsley, kelp, and mixtures thereof.

22. The pet chew of claim 20, wherein the additional ingredient comprises the antioxidant selected from the group consisting of purified natural antioxidants and synthetic antioxidants.

23. The pet chew of claim 20, where in the additional ingredient comprises the colorant selected from the group consisting of titanium dioxide, azo dyes, chlorophyll, xanthophyll, carotene, indigo, iron and titanium oxides, and carbon black.

24. The pet chew of claim 20, wherein the additional ingredients individually comprise less than 6% by weight of the pet chew.

25. The pet chew of claim 1, further comprising fiber in an amount ranging not more than 60% by weight of the pet chew.

26. The pet chew of claim 25, wherein the fiber is selected from the group consisting of cellulose fiber, wheat bran, innulin, wood fiber, sisal fiber, and mixtures thereof.

27. The pet chew of claim 25, wherein the amount of fiber ranges from 1% to 20% by weight of the pet chew.

28. The pet chew of claim 1, further comprising an antimicrobial agent in an amount ranging from 0.1% to 2% by weight of the pet chew.

29. The pet chew of claim 28, wherein the antimicrobial agent comprises citracidal.

30. A method of making a pet chew product, the method comprising the steps of:
forming a mixture of ingredients that include a gluten matrix, an acidulent in an effective amount for reducing undesirable flora in the mouth of an animal, a chelator in an effective amount for reducing calculus buildup in the mouth of an animal, and sufficient liquid for purposes of extrusion processing to form a pet chew;
processing the mixture by screw extrusion equipment,
extruding the mixture to form an extrudate, and
shaping the extrudate to form the pet chew product.

31. The method of claim 30, wherein the shaping step comprises cutting the extrudate.

32. The method of claim 30, wherein the step of extruding comprises raising a temperature of the mixture to a temperature that is sufficient to denature the gluten.

33. The method of claim 32 wherein the temperature that is sufficient to denature the gluten is at least 80° C.

34. A food product produced according to the method of claim 30.

35. The method of claim 30, wherein the ingredients further comprise from 1% to 20% fiber, from 0.25% to 0.7% clove powder, and from 5% to 12% liver digest by weight of the pet chew.

36. A premix for use in producing pet chews, comprising:
gluten;
an acidulent in an effective amount for reducing undesirable flora in the mouth of an animal; and
a chelator in an effective amount for reducing calculus buildup in the mouth of an animal.

37. The premix of claim 36, wherein the gluten is present in an amount ranging from 45% to 80% by weight of the premix.

38. The premix of claim 36, wherein the acidulent is present in an amount ranging from 0.01% to 3% by weight of the premix.

39. The premix of claim 38, where the acidulent includes an organic acid.

40. The premix of claim 39, wherein the organic acid comprises acetic acid.

41. The premix of claim 36, wherein the chelator is present in an amount ranging from 0.2% to 0.6% by weight of the premix.

42. The premix of claim 41, wherein the chelator comprises sodium hexametaphosphate.

43. The premix of claim 36 further comprising a palatability enhancer.

44. The premix of claim 43, wherein the palatability enhancer is selected from the group consisting of meat and poultry broth concentrate or spray-dried powder, liver and liver digest broth concentrate or powder, hydrolyzed proteins, clove, clove oil, yeast extract, garlic flavor, meat flavors, cheese flavor, fruit flavor, distillery dry feed, smoke flavor and combinations thereof.

45. The premix of claim 44, wherein the palatability enhancer comprises clove powder mixed with another member of the group.

46. The premix of claim 43, wherein the palatability enhancer comprises clove powder.

47. The premix of claim 36, further comprising fiber in an amount not more than 60% by weight of the pet chew.

48. The premix of claim 47, wherein the fiber is selected from the group consisting of cellulose fiber, wheat bran, innulin, wood fiber, sisal fiber, and mixtures thereof.

49. The premix of claim 47, wherein the amount of fiber ranges from 1% to 20% by weight of the premix.

50. The premix of claim 36, further comprising an antimicrobial agent in an amount ranging from 0.1% to 2% by weight of the premix.

51. The premix of claim 50, wherein the antimicrobial agent comprises citracidal.
